(19) United States
(12) Patent Application Publication
(10) Pub. No.: US 2021/0009247 A1
(43) Pub. Date: Jan. 14, 2021

(54) DIVING MASK COMPRISING A LI-FI COMMUNICATION MODULE

(71) Applicant: Jean-Baptiste SEILLIERE, Chambésy (CH)

(72) Inventor: Jean-Baptiste SEILLIERE, Chambésy (CH)

(21) Appl. No.: 17/041,515

(22) PCT Filed: Mar. 26, 2019
(86) PCT No.: PCT/EP2019/025085

§ 371 Date: Sep. 25, 2020

(30) Foreign Application Priority Data
Mar. 26, 2018 (FR) FR1870335

(51) Int. Cl. B63C 11/26; B63C 11/12; B63C 11/16; H04B 10/116; H04B 13/02; H04B 10/54; H04B 10/66

(52) U.S. Cl. CPC B63C 11/26; B63C 11/12; B63C 11/16; H04B 10/116; H04B 13/02; H04B 10/502; H04B 10/66; B63C 2011/123; B63C 2011/128; B63C 2011/165; H04B 10/541

(57) ABSTRACT

The invention relates to a diving mask (10) comprising a telecommunication system (190) configured to allow the establishment of one-way or two-way light communication, specifically according to a communication protocol of the Li-fi type. For this purpose, the telecommunication system (190) comprises a light communication module (150) comprising at least one light source (151) and an electronic control board (156) for controlling said at least one light source (151) so as to emit a light signal of which the amplitude is modulated as a function of an electronic signal encoded by said electronic control board (156). The invention also relates to an underwater light communication method (200).

### TECHNICAL FIELD

The technical context of the present invention is that of underwater diving equipment, and in particular underwater diving masks. More particularly, the invention relates to a diving mask for snorkelers or for dives using self-contained underwater breathing apparatus. Another particularly advantageous use of the present invention is that of deep-water explorations and underwater mining operations.

### PRIOR STATE OF THE ART

The state of the art discloses numerous devices that enable breathing underwater. According to a first known variation, such devices comprise a hookah of which a first end is in fluidic communication with the snorkeler's mouth and a second end is located in the open air so as to allow the snorkeler to inhale fresh air. This first known variation is particularly suited to underwater diving just beneath the water surface, such as when snorkeling for example.

According to a second known variation, these devices comprise a tank of compressed air, a regulator and a pipe fluidically connecting the regulator to the snorkeler's mouth so as to enable him to breathe underwater.

In order to communicate underwater, telecommunication systems are also known that comprise a microphone and a loudspeaker associated with a radio emitter/receiver. These systems thus emit radio waves in all directions in order to transmit the signal carried by the radio wave to a radio receiver of another telecommunication system, thus allowing two or more snorkelers to communicate with one another on one or more channels.

In a known way, such telecommunication systems are associated with devices that enable breathing under water, thus making underwater communication possible during diving.

However, such systems are often very cumbersome, heavy and energy-intensive, making their use complex for a snorkeler. Furthermore, such systems emit radio waves in all directions, thus disturbing the tranquility of marine animals that can have a certain sensitivity to such radio waves.

The aim of the present invention is to propose a new diving mask in order to resolve, at least to a large extent, the above-mentioned problems and also to lead to other advantages.

Another object of the invention is to reduce the environmental impact of an underwater communication.

Another object of the invention is to facilitate underwater communication during snorkeling.

### DESCRIPTION OF THE INVENTION

According to a first aspect of the invention, at least one of the above-mentioned objectives is achieved with a diving mask comprising (i) a peripheral frame provided with a visor, (ii) a flexible skirt fixed to the peripheral frame, said skirt forming, with the peripheral frame and the visor, at least one chamber for vision, called the vision chamber, (iii) a telecommunication system comprising a light communication module enabling the transmission of a digital signal, said light communication system comprising an electronic control board and a light source configured to emit a light signal modulated as a function of the digital signal encoded by said electronic control board.

According to a first aspect of the invention, the light source of the light communication module is configured to emit a light signal intermittently as a function of the modulation performed. An intermittent light signal means that the light signal generated by the light source is not invariant when said light source is configured to emit such a light signal: the intensity and/or frequency and/or phase thereof is variable. A modulation frequency of the light signal is advantageously greater than several Mega-Hertz.

The peripheral frame of the diving mask according to the first aspect of the invention is designed to surround at least part of the snorkeler's face, and at the very least to surround at least the eyes of said snorkeler. The visor is integral with the peripheral frame and extends into the interior thereof in order to offer the snorkeler the widest possible field of vision. According to a first variation, the visor is inserted into the peripheral frame and securely fixed thereto. According to a second variation, the visor originates from the material of the peripheral frame so that together they form a single piece and cannot be detached from one another without damaging the visor and/or the diving mask.

The flexible skirt is configured so as to prevent the water from infiltrating between the diving mask according to the first aspect of the invention and the snorkeler when he is wearing said mask. For this purpose, the flexible skirt plays the role of a watertight or quasi-watertight seal when it is pressed and kept compressed against the face of the snorkeler wearing the diving mask according to the first aspect of the invention.

So as to make it easier to keep the diving mask according to the first aspect of the invention against the snorkeler's face, said diving mask can advantageously comprise a removable attachment system, such as for example at least one strap connecting the diving mask at two points of attachment located on either side of the visor.

Thus, the diving mask according to the first aspect of the invention enables a digital signal to be emitted from said diving mask, in order to establish a communication with a receiver system capable of receiving the light signal emitted by the light source. The invention according to its first aspect thus limits the emission of radio waves in all directions during snorkeling and, at the same time, reduces the environmental impact of an underwater communication between two or more snorkelers. More generally, the invention according to its first aspect thus does away with radio wave emissions used until now.

The diving mask according to the first aspect of the invention thus facilitates communication between two snorkelers, each wearing such a diving mask, both when they are immersed beneath the surface of the water and also when they have their head out of the water: the diving mask according to the first aspect of the invention thus enables easy communication with another snorkeler without having to remove said diving mask.

The diving mask according to the first aspect of the invention advantageously comprises at least one of the above improvements, the technical characteristics forming these improvements being adopted individually or in combination:
the light signal generated by the light source is modulated in amplitude and/or in frequency as a function of the digital signal encoded by the electronic control board;
the light communication module is advantageously a LIFI module configured to emit and/or receive a digital signal encoded according to a so-called LIFI (Light-Fidelity) communication protocol. The LiFi communication protocol is described in particular in IEEE Standard 802.15.7 which provides the visible light communication protocols covered by the present invention;
the light source is of the type with at least one electroluminescent diode emitting a light signal the wavelength of which is located in the spectrum visible to the human eye, that is to say advantageously between 450 nm and 700 nm. Preferably, an emission spectrum of the light source has a maximum energy in the wavelengths corresponding to red and/or green radiations in order to limit the impact of light emissions on underwater flora and fauna. Possibly or in addition, the emission spectrum of the light source can also extend into the infrared or near-infrared range. Alternatively, the emission spectrum of the light source is exclusively or for the most part situated in the infrared range. Advantageously, this configuration reduces the disturbance of the light communication module—when in operation—on the underwater flora and fauna;
the light communication module is housed in a sealed box, said box being fixed securely to the peripheral frame. Preferably, the box is detachable from the peripheral frame. More particularly, the box is fixed to the peripheral frame on the outside of the vision chamber so as not to impede the snorkeler's vision and to enable him to see ahead;
the box is fixed securely to the peripheral frame by means of an articulation means enabling the light communication module to be oriented in a so-called direction of communication. This advantageous configuration allows the snorkeler to orient the communication module—and more particularly the light source—in the direction of communication in which another snorkeler with whom he may wish to communicate is located;
the articulation means comprises at least one pivot and/or a ball joint and/or a telescopic arm so as to facilitate the orientation of the light communication module in the chosen direction of communication;
the telecommunication system comprises a battery in order to provide electrical energy to at least the light communication module. According to a first variation, the battery is housed in the box of the light communication module, near the electronic control board and/or the light source. According to a second variation, the battery is housed in a case—preferably sealed—separate from the box housing the light communication module, said battery being connected electrically to said light communication module by means of electrical conductor(s). This advantageous configuration facilitates in particular the recharging of the battery between two snorkeling operations;
the telecommunication system comprises a photoreceptor. This advantageous configuration enables two-way communication between two telecommunication systems and, more particularly, between two diving masks according to the first aspect of the invention;
the photodetector advantageously takes the form of at least one photodiode, of which the bandwidth is compatible with the wavelength of the light source of the light communication module;
the at least one photodiode is preferably housed near the light source. In other words, the at least one photodiode is advantageously housed in the box of the light communication module in order to improve the compactness of the telecommunication system;
the photoreceptor of the telecommunication system is electrically connected to the electronic control board in order to demodulate a light signal received by said photoreceptor. During demodulation of the light signal received by the photodetector, the electronic control board generates an electrical signal—advantageously digital—which thus carries information carried by the light signal received by the photodetector;
the telecommunication system comprises a microphone and a loudspeaker. This advantageous configuration thus enables the snorkeler to speak with, and respectively hear, another snorkeler equipped with a compatible telecommunication system, such as for example a diving mask according to the first aspect of the invention;
the microphone and/or loudspeaker are connected to the electronic control board of the light communication module by means of a wired connection. Alternatively, the microphone and/or the loudspeaker are connected to the electronic control board of the light communication module by means of a wireless connection. Thus, when the snorkeler speaks into the microphone of the diving mask according to the first aspect of the invention, the electrical signal generated by the microphone is carried to the electronic control board that encodes said electrical signal into a digital signal that controls the light source. As regards this digital signal, the light source emits a light signal the modulation of which is directly linked to the digital signal encoded by the electronic control board, thus enabling the audio message recorded by the microphone of the diving mask according to the first aspect of the invention to be transmitted by light communication. Similarly, when the diving mask according to the first aspect of the invention receives a light signal—originating for example from another diving mask according to the first aspect of the invention—the photodetector of the light communication module converts the light signal received into an electrical signal that is transmitted to the electronic control board. The electronic control board demodulates the electrical signal into a demodulated electrical signal that is transported to the loud speaker of the diving mask according to the first aspect of the invention, thus enabling the snorkeler to hear an audio signal;
the peripheral frame of the diving mask according to the first aspect of the invention comprises an intermediate partition that separates the vision chamber from an adjacent chamber for breathing, called the breathing chamber, said intermediate partition being arranged to rest above the nose of a user of the diving mask, so that the user's mouth and nose are accommodated in the breathing chamber and the user's eyes are accommodated in the vision chamber. Advantageously, the intermediate partition and the flexible skirt form one piece;
the diving mask according to the first aspect of the invention comprises a breathing tube integral with the peripheral frame, said breathing tube being in fluidic communication with the breathing chamber. This advantageous configuration allows the snorkeler to breathe, one upper end of the breathing tube being free and designed to be positioned out of the water when the snorkeler is wearing the diving mask according to the first aspect of the invention. One lower end of the breathing tube is advantageously in fluidic communication with the breathing chamber so as to allow a free circulation of air between the free end of said breathing tube and said breathing chamber;
Advantageously, the peripheral frame and the breathing tube are monolithic and together form a single piece resulting from a single manufacturing process, for example by molding. This advantageous configuration simplifies the manufacture of the diving mask, particularly the peripheral frame. Alternatively, the breathing tube is fixed detachably to the diving mask according to the first aspect of the invention, and more particularly to the peripheral frame;
according to a first variation, at least one part of the light communication module is located at one free end of the breathing tube in relation to the breathing chamber. This advantageous configuration allows the light communication module to be deployed remotely in relation to the snorkeler's face, thus improving the comfort of use and also improving the light communication, by preventing the snorkeler's face from blocking the emission of the light rays generated. In particular, only the light source of the light communication module is preferably located at the free end of the breathing tube in relation to the breathing chamber. Advantageously, the entire light communication module, housed in a single box, is securely fixed at a free end of the breathing tube. The light communication module is preferably fixed detachably to the free end of the breathing tube;
according to a second variation, the light communication module is housed on part of the peripheral frame located opposite the breathing chamber in relation to the vision chamber. In other words, the light communication module is advantageously located above the visor of the peripheral frame in relation to the breathing chamber, so as not to reduce the angle of vision accessible through the diving mask according to the first aspect of the invention.

According to a second aspect of the invention, an underwater light communication method is proposed, comprising the following steps:
a step of acquisition of a sound signal via a microphone of an underwater telecommunication system;
a step of encoding the sound signal into a digital control signal of a light source, the encoding step being performed by an electronic control board of the underwater telecommunication system;
a step of controlling the light source in order to emit a light signal of which an amplitude is modulated as a function of the digital control signal.

Possibly, the underwater light communication method according to the second aspect of the invention advantageously comprises the following steps:
a step of receiving the light signal by a photodetector of an underwater telecommunication system;
a step of decoding the light signal into a decoded digital signal, the step of decoding being performed by the electronic control board of the underwater telecommunication system;
a step of generating a sound signal by means of a loudspeaker of the underwater telecommunication system.

The steps of receiving the light signal and/or decoding and/or generating the sound signal can be collectively or individually performed before the steps of acquiring the sound signal and/or encoding and/or controlling the light sources.

The light communication method thus allows the establishment of one-way or two-way communication by emitting and/or receiving a light signal carrying oral information. The light communication method is particularly suited to underwater communication and enables easy communication over long distances.

According to a third aspect of the invention, an underwater telecommunication system is proposed comprising means configured to implement all of the steps of the light communication method according to a second aspect of the invention. Preferably, the means of the underwater telecommunication system according to the third aspect of the invention comprise at least one diving mask according to the first aspect of the invention or according to any of its improvements, and preferably two diving masks according to the first aspect of the invention or according to any of its improvements.

Various embodiments of the invention are envisaged, integrating, according to all of their possible combinations, the different optional characteristics described herein.

### DESCRIPTION OF THE FIGURES

Further characteristics and advantages of the invention will emerge from the following description on the one hand and from several embodiments given by way of non-limiting example with reference to the accompanying drawings on the other, in which:

FIG. 1 shows a first embodiment of a diving mask according to a first aspect of the invention;

FIG. 2 shows a second embodiment of a diving mask according to the first aspect of the invention;

FIG. 3 shows a third embodiment of a diving mask according to the first aspect of the invention;

FIG. 4 shows a fourth embodiment of a diving mask according to the first aspect of the invention;

FIG. 5 shows an embodiment of an underwater light communication method according to the second aspect of the invention.

Clearly, the characteristics, variations and different embodiments of the invention can be associated with one another, in various combinations, provided that they are not incompatible with or exclusive of one another. In particular, variations of the invention can be envisaged that comprise only a selection of the characteristics described below in a manner isolated from the other characteristics described, if this selection of characteristics is sufficient to confer a technical advantage or distinguish the invention in relation to the prior state of the art.

In particular, all of the variations and all of the embodiments described can be combined together if there is no impediment to this combination from a technical point of view.

In the figures, the same reference numeral is used to indicate elements that are common to several figures.

### DETAILED DESCRIPTION OF THE INVENTION

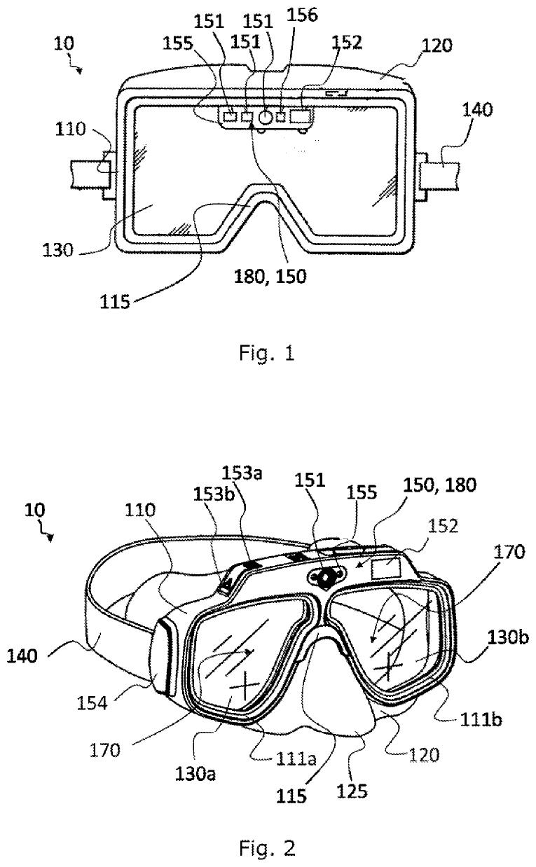

With reference to FIGS. 1 to 4, the invention according to its first aspect relates to a diving mask 10 comprising (i) a peripheral frame 110 provided with a visor 130, 130a, 130b, (ii) a flexible skirt 120 fixed to the peripheral frame 110, said flexible skirt 120 forming, with the peripheral frame 110 and the visor 130, 130a, 130b, at least one chamber for vision, called the vision chamber 170, (iii) a telecommunication system 190 comprising a light communication module 150 enabling the transmission of a digital signal, said light communication module 150 comprising an electronic control board 156 and a light source 151 configured so as to emit a light signal modulated as a function of the digital signal encoded by said electronic control board 156.

The invention according to its first aspect thus concerns a diving mask 10 that can take numerous forms and of which several embodiments are illustrated in FIGS. 1 to 4. According to a first possible use of the diving mask 10 according to the first aspect of the invention, said diving mask 10 is suitable for deep-water dives and/or during dives of several tens of minutes, said diving mask 10 being capable of use in combination with compressed air storage devices. According to a second possible use, the diving mask 10 according to a first aspect of the invention enables swimming near the surface—in a natural environment such as the sea or natural reservoirs, or in an artificial basin—so as in particular to practice underwater fishing or the exploration of sea beds without using a scuba tank.

In general, the diving mask 10 according to a first aspect of the invention is a mask that protects at least the eyes of its wearer so as to enable him to keep his eyes open while snorkeling. Such diving masks 10—called partial masks—are described in particular with reference to FIGS. 1 to 3. In these variations, the peripheral frame 110 of the diving mask 110 extends around an upper part of the face of its wearer, so as to frame his eyes. The peripheral frame 110 advantageously comprises a bridge 115 designed to rest on the wearer's nose.

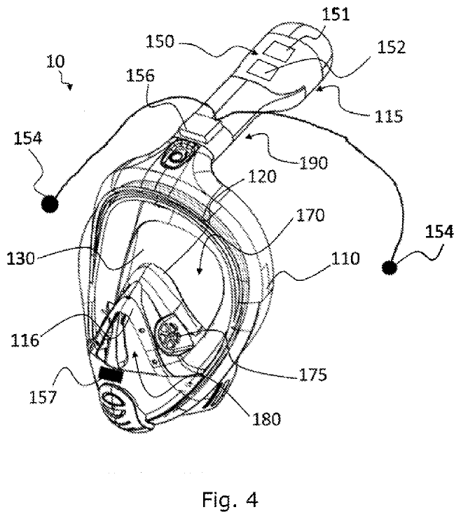

Possibly, the diving mask 10 according to a first aspect of the invention also allows its wearer to breathe without the need to take his head out of the water. For this purpose, and as illustrated in the embodiment in FIG. 4, the diving mask—called a full mask—comprises a breathing tube 115. The invention, when referring to a breathing tube 115, means in particular but not exclusively a snorkel having a distal end open in relation to the peripheral frame 110 or a flexible tube connected to a compressed air source carried by the wearer of the diving mask 10.

In the case of a partial diving mask 10 or a full diving mask 10, the peripheral frame allows the visor 130, 130a, 130b to be arranged in front of the eyes of the wearer of said diving mask 10. Generally speaking, the visor 130, 130a, 130b takes the form of a transparent or translucent facial screen through which the wearer of the diving mask 10 can see.

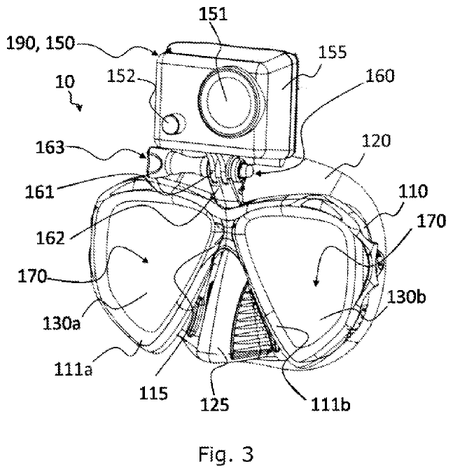

According to a first variation shown in FIGS. 1 and 4, the peripheral frame 110 is provided with a single visor 130 that extends from one edge to the other of said peripheral frame, said visor 130 extending in front of the wearer's eyes. According to a second variation shown in FIGS. 2 and 3, the diving mask 10 comprises two visors 130a, 130b extending in front of only one of the wearer's eyes. In this variation, the peripheral frame comprises a surround 11a, 11b configured to encircle each corresponding visor 130a, 130b. In other words, the surround 111a associated with a first visor 130a extends around said first visor 130a following a closed contour; and the surround 111b associated with a second visor 130b extends around said second visor 130b following a closed contour.

The visor(s) 130, 130a, 130b are advantageously fixed securely to the peripheral frame 110 or surround 11a, 11b possibly in a detachable manner. According to another variation, the visor(s) 130, 130a, 130b of the diving mask 10 originate from the same material as the peripheral frame 110.

The peripheral frame 110 and/or the visor 130 of the diving mask according to the first aspect of the invention are advantageously formed of a plastic material. Advantageously, in order to reduce the production costs, the peripheral frame 110 and/or the visor 130 are obtained by manufacturing methods such as molding or extrusion.

In order to rest in a comfortable and sufficiently sealed manner against the face of the wearer of the diving mask 10 according to the first aspect of the invention, the flexible skirt 120 of said diving mask 10 extends around the peripheral frame 110 and is designed to rest against the face of said user. In other words, the flexible skirt 120 is located alongside a face of the diving mask 10 that rests against the face of its wearer. The flexible skirt 120 is called flexible because it is made of a material that is more deformable than the peripheral frame.

By way of non-limiting example, the flexible skirt 120 can be made of silicone. In the examples shown in FIGS. 2 and 3, the flexible skirt 120 extends furthermore between the two surrounds 11a, 11b of the peripheral frame 110 in order to cover and protect the nose of the wearer of the diving mask 10.

In order to be held in place on the face of its wearer, the diving mask 10 according to the first aspect of the invention advantageously comprises at least one removable attachment system 140 that takes the form of at least one strap connecting two opposite lateral ends of the peripheral frame 110, as shown in FIGS. 1 and 2.

Consecutively, the diving mask 110 defines at least one vision chamber 170 delimited by the visor 130, 130a, 130b, the peripheral frame 110 and the flexible skirt 120. The vision chamber 170 thus forms a volume of air between the diving mask 110 and the face of its wearer, contributing to the comfort of use of said diving mask 10. In the case of a partial diving mask 10, the vision chamber 170 is delimited by the peripheral frame 110 and extends to the middle of the face, between the wearer's nose and mouth. In the embodiments shown in FIGS. 2 and 3, the diving mask comprises two vision chambers 170, each vision chamber 170 facing one of the wearer's eyes. Possibly, the vision chambers 170 are independent of one another and are separated by a central wall located at point 115 of the peripheral frame 110. In the embodiment shown in FIG. 1, the diving mask 10 comprises a single vision chamber 170.

Possibly, and as illustrated in FIG. 4, the peripheral frame 110 of the diving mask 10 comprises an intermediate partition 116 that separates the vision chamber 170 from a breathing chamber 180. The breathing chamber 180 is adjacent to the vision chamber 170. More particularly, the breathing chamber 180 is located beneath the vision chamber 170: it extends around the mouth and/or nostrils of the wearer equipped with the diving mask 10. For this purpose, the intermediate partition 116 of the peripheral frame 110 is arranged so as to rest against the nose of the wearer of the diving mask 10, while a lower end of the peripheral frame 110 extends around—even beneath—the wearer's chin. This advantageous configuration thus allows the wearer's mouth and nose to be accommodated in the breathing chamber 180, while the wearer's eyes are accommodated in the vision chamber 170.

As shown in the embodiment in FIG. 4, the vision chamber 170 is in fluidic communication with the breathing chamber 180 by means of a valve 175 located in the intermediate partition 116. This advantageous configuration limits the formation of condensation in the visor 170 while the mask 10 is being worn.

In the embodiment shown in FIG. 4, the diving mask 10 comprises a breathing tube 115 integral with the peripheral frame 110. According to a variation, the breathing tube 115 originates from the material of the peripheral frame 110, so that said breathing tube 115 and said peripheral frame 110 together form a single piece and cannot be detached from one another without damaging one of them. According to an alternative variation, the breathing tube 115 is securely and detachably fixed to the peripheral frame 110, with the aid of temporary fixing means, such as by click-fitting for example.

The breathing tube 115 is in fluidic communication with the breathing chamber 180. For this purpose, the peripheral frame 110 houses at least one fluidic pipe that extends from one end of the breathing tube 115 engaging with said peripheral frame 110, up to an opening in said peripheral frame 110 located in the breathing chamber 180.

In the embodiment shown in FIG. 4, the breathing tube 115 takes the form of a snorkel housed on top of the diving mask 10. Clearly, the invention also includes other configurations of the breathing tube 115, such as for example a breathing tube 115 located on a lateral edge of the diving mask 10, or a front connection to the diving mask 10 for a regulator such as that used in diving, said front connection being located at the breathing chamber 180, near the mouth of the wearer of the diving mask 10 and through the peripheral frame 110 and/or the visor 130 taken up at said breathing chamber 180.

According to the invention, the diving mask 10 comprises the telecommunication system 190 as previously described to allow the establishment of an underwater communication between two or more snorkelers. FIGS. 1 to 4 show different configurations of telecommunication systems 190 which will be described in detail in the following paragraphs.

In the example shown in FIG. 1, the telecommunication system 190 is integrated in a sealed box 155 that is located at a top part of the visor 130 of the diving mask 10. Possibly the box 155 originates from the material of the peripheral frame 110. In other words, the telecommunication system 190 can advantageously be housed in a housing of the peripheral frame 110, said housing forming the box 155 of the telecommunication system 190.

According to a variation, the box 155 is housed between the peripheral frame 110 and the visor 120 of the diving mask 10, so that said visor 120 entirely covers the telecommunication system 190 and thus guarantees its sealing. According to another variation, the box 155 housing the telecommunication system 190 is located at the front of the visor 120 of the diving mask 10, on the outside of the vision chamber 130 of said diving mask 10.

In the embodiment shown in FIG. 1, the telecommunication system 190 comprises the light communication module 150 housed in the box 155 and comprises three light sources 151 and a photodetector 152. The three light sources 151 are advantageously oriented in the different directions of communication, a first light source 151 being preferably oriented on the right of the diving mask 10, a second light source 151 being preferably oriented on the left of said diving mask 10 and a third light source 151 being preferably oriented on the front of said diving mask 10. This advantageous configuration increases a solid angle according to which the telecommunication system 190 is able to emit a light signal.

The light sources 151 are electrically connected to the electronic control board 155 in order to modulate the light signal that will be emitted by the light sources as a function of an electronic signal; and the photodetector 152 is electrically to the electronic control board 156 in order to demodulate the light signal detected by said photodetector 152 into an electronic signal. This advantageous configuration allows the establishment of a two-way light communication, the telecommunication system 190 being configured to allow digital data to be emitted and received via a modulated light signal—for example in amplitude—emitted by the light sources 151 and respectively received by the photodetector 152. The communication protocol is advantageously of the LIFI type as described previously.

In the example shown in FIG. 2, the telecommunication system 190 is integrated into a sealed box 155 that is located above the peripheral frame 110, said telecommunication system 190 being housed in the peripheral frame 110 forming said box 155.

In the embodiment shown in FIG. 2, the telecommunication system 190 comprises the light communication module 150 housed in the box 155 and comprises a single light source 151 and a single photodetector 152. A solid angle of detection of the photodetector 152 at least partially—and preferably completely—overlaps a solid angle of emission of the light source 151.

The light sources 151 of the light communication module 150 shown in FIG. 2 are connected electrically to the electronic control board 155 in order to modulate the light signal that will be emitted by the light sources as a function of an electronic signal; and the photodetector 152 is electrically to the electronic control board 155 in order to demodulate the light signal detected by said photodetector 152 into an electronic signal. This advantageous configuration allows the establishment of two-way light communication, the telecommunication system 190 being configured to allow digital data to be emitted and received via a modulated light signal—for example in amplitude —emitted by the light sources 151 and respectively received by the photodetector 152. The communication protocol is advantageously of the LIFI type as described previously.

In the embodiment shown in FIG. 2, the telecommunication system 190 also comprises two loudspeakers 154 located at the lateral ends of the peripheral frame 110 of the diving mask 10. Each loudspeaker being electrically connected to the electronic control board 156 in order to convert the light signal received by the photodetector 152 into an audio signal that will be audible by the wearer of the diving mask 10.

Furthermore, the diving mask 10 shown in FIG. 2 comprises control buttons 153a, 153b so as, for example, to control the light source 151 and/or the loudspeakers 154 and/or the photoreceptor 152.

In the embodiment shown in FIG. 3, the light communication module 150 of the telecommunication system 190 is housed in a box 155 fixed securely to the peripheral frame 110 of the diving mask 10 by means of an articulation means 160 for orienting said light communication module 150 in a particular direction of communication. The articulation means 160 here takes the form of a ball joint and/or a pivot 161 in order to pivot said light communication module 150 about at least one axis of rotation. In the embodiment shown in FIG. 3, the articulation means also comprises an arm 162, possibly telescopic, in order to raise the light communication module 150 in relation to the peripheral frame 110 and/or the wearer's head and to facilitate orientation of the light communication module 150 in the chosen direction of communication.

In the embodiment shown in FIG. 4, the light communication module 150 is housed at one free end of the breathing tube 115 so as not to be impeded by the head and/or body of the wearer of the diving mask 10. More particularly, the light source 151 and the photodetector 152 are located on a front face of the breathing tube 115.

The diving mask 10 shown in FIG. 4 also comprises a microphone 157 located in the area of the breathing chamber 180. More particularly, the microphone 157 is located near, or even opposite, the mouth of the wearer of the diving mask 10. The microphone 157 is advantageously fixed onto the visor 130 or onto the peripheral frame 110 of the diving mask 10.

The diving mask 10 shown in FIG. 4 also comprises two loudspeakers 154 taking the form of earphones.

In the embodiment shown in FIG. 4, the loudspeakers 154, the microphone 157, the light source 151 and the photodetector 152 are electrically connected—preferably by a wired connection—to the electronic control board 156 to allow the establishment of two-way communication as previously described.

As previously described and for each of the embodiments shown in FIGS. 1 to 4, each light source 151 of the light communication module 150 advantageously comprises one or more electroluminescent diodes configured so as to emit a light signal with a wavelength of between 450 nm and 700 nm. As previously described, and for each of the embodiments shown in FIGS. 1 to 4, the photodetector 152 is of a photodiode type with a spectral range that includes the wavelengths of the light sources 151 of the light communication module 150.

Lastly, the telecommunication system 190 advantageously comprises an energy source, not shown in FIGS. 1 to 4, which may for example take the form of a battery mounted on the diving mask 10.

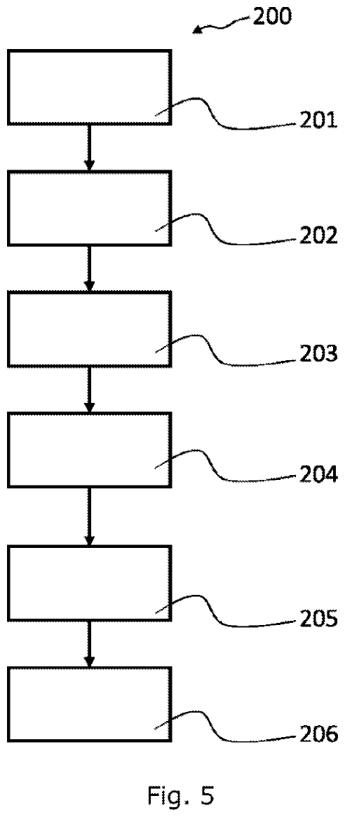

FIG. 5 shows an embodiment of a method 200 of underwater light communication according to the second aspect of the invention. Such a method 200 of underwater light communication can advantageously be implemented by the diving mask 10 according to the first aspect of the invention and as previously illustrated with reference to FIGS. 1 to 4. The method 200 of underwater light communication comprises the following steps:
a step 201 of acquisition of a sound signal via the microphone 157 of the telecommunication system 190;
a step 202 of encoding the sound signal into a digital control signal of the light source 151, the encoding step being performed by the electronic control board 156 of the telecommunication system 190;
a step 203 of controlling the light source 151 in order to emit a light signal with an amplitude that is modulated as a function of the digital control signal, and preferably according to a LIFI communication protocol;
a step 204 of the light signal being received by the photodetector 152 of the telecommunication system 190;
a step 205 of decoding the light signal into a decoded digital signal, the decoding step being performed by the electronic control board 156 of the telecommunication system 190;
a step 206 of a sound signal being generated by means of one or more loudspeakers 154 of the telecommunication system 190.

In summary, the invention relates to a diving mask 10 comprising a telecommunication system 190 configured to allow the establishment of one-way or two-way light communication, and more particularly according to a LIFI type communication protocol. For this purpose, the telecommunication system 190 comprises a light communication module 150 comprising at least one light source 151 and an electronic control board 156 in order to control said at least one light source 151 so as to emit a light signal the amplitude of which is modulated as a function of an electronic signal encoded by said electronic control board 156.

Clearly, the invention is not limited to the embodiments that have just been described and numerous adaptations can be made to these embodiments without departing from the scope of the invention. In particular, the different characteristics, forms, variations and embodiments of the invention can be associated with one another according to various combinations provided that they are not incompatible or exclusive of one another. In particular, all of the variations and embodiments described above can be combined together.

1. Diving mask (10) comprising:
a peripheral frame (110) provided with a visor (130, 130a, 130b);
a flexible skirt (120) fixed to the peripheral frame (110), said flexible skirt (120) forming, with the peripheral frame (110) and the visor (130, 130a, 130b), at least one chamber for vision, called the vision chamber (170);
a telecommunication system (190) comprising a light communication module (150) enabling the transmission of a digital signal, said light communication system (150) comprising an electronic control board (156) and a light source (151) configured to emit a light signal modulated as a function of the digital signal encoded by said electronic control board (156).

2. Diving mask (10) according to claim 1, wherein the light communication module (150) is housed in a sealed box (155), said box (155) being fixed securely to the peripheral frame (110).

3. Diving mask (10) according to claim 2, wherein the box (155) is fixed securely to the peripheral frame (110) by means of an articulation means (160) enabling the light communication module (150) to be oriented in a so-called direction of communication.

4. Diving mask (10) according to claim 3, wherein the articulation means (160) comprises at least one pivot (161) and/or a ball joint and/or a telescopic arm.

5. Diving mask (10) according to claim 1, wherein the telecommunication system (190) comprises a photoreceptor (152), said photoreceptor (152) of the telecommunication system (190) being electrically connected to the electronic control board (156) in order to demodulate a light signal received by said photoreceptor (152).

6. Diving mask (10) according to claim 1, wherein the telecommunication system (190) comprises a microphone (157) and a loudspeaker (154), said microphone (157) and/or said loudspeaker (154) being connected to the electronic control board (156) of the light communication module (150) by means of a wired connection.

7. Diving mask (10) according claim 1, wherein the peripheral frame (110) comprises an intermediate partition (116) that separates the vision chamber (170) from an adjacent chamber for breathing, called the breathing chamber (180), said intermediate partition (116) being arranged to rest above the nose of a user of the diving mask (10), so that the user's mouth and nose are accommodated in the breathing chamber (180) and the user's eyes are accommodated in the vision chamber (170).

8. Diving mask (10) according to claim 7, wherein the diving mask (10) comprises a breathing tube (115) integral with the peripheral frame (110), said breathing tube (115) being in fluidic communication with the breathing chamber (180).

9. Diving mask (10) according to claim 8, wherein at least one part of the light communication module (150) is located at one free end of the breathing tube (115) in relation to the breathing chamber (180).

10. Diving mask (10) according to claim 7, wherein the light communication module (150) is housed on part of the peripheral frame (110) located opposite the breathing chamber (180) in relation to the vision chamber (170).

11. Underwater light communication method (200), comprising the following steps:
a step (201) of acquisition of a sound signal via a microphone (157) of an underwater telecommunication system (190);
a step (202) of encoding the sound signal into a digital control signal of a light source (151), the encoding step being performed by an electronic control board (156) of the underwater telecommunication system (190);
a step (203) of controlling the light source (151) in order to emit a light signal of which an amplitude is modulated as a function of the digital control signal.

12. Underwater light communication method (200) according to claim 11, wherein said method comprises the following steps:
a step (204) of receiving the light signal by a photodetector (152) of the underwater telecommunication system (190);
a step (205) of decoding the light signal into a decoded digital signal, the step of decoding being performed by the electronic control board (156) of the underwater telecommunication system (190);
a step (206) of generating a sound signal by means of a loudspeaker of the underwater telecommunication system (190).

13. Underwater telecommunication system (190) comprising means configured to implement all of the steps of the underwater light communication method according to claim 11.
